(19) United States
(12) Patent Application Publication
(10) Pub. No.: US 2006/0103135 A1
(43) Pub. Date: May 18, 2006

(54) Exhaust pipe coupling

(76) Inventor: Michael Scott, Scott, AR (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/282,242

(22) Filed: Nov. 18, 2005

Related U.S. Application Data
(60) Provisional application No. 60/629,023, filed on Nov. 18, 2004.

(51) Int. Cl. F16L 17/00

(52) U.S. Cl. 285/367

(57) ABSTRACT

The invention relates to a coupling for an exhaust system for a vehicle having an internal combustion engine. The coupling includes a female pipe, a male pipe, and a clamping collar to couple together the pipes. The coupling includes a post and slot connection having a pair of posts and a pair of slots between the clamping collar and the pipes for connecting the pipes. The clamping collar surrounds and slides along the female pipe and includes an annular cam presenting a pair of openings for sliding the clamping collar over the posts. The annular cam presents an axially facing cam surface having a slope increasing circumferentially from each of the openings for sliding frictional engagement with the posts.

### CROSS REFERENCE TO RELATED APPLICATION

This application claims the benefit of U.S. provisional patent application Ser. No. 60/629,023, filed Nov. 18, 2004.

### BACKGROUND OF THE INVENTION

1. Field of the Invention

The invention relates to a coupling for an exhaust system of a vehicle having an internal combustion engine.

2. Description of the Prior Art

Exhaust couplings of the prior art typically include a female pipe having a first coupling end and a male pipe having a second coupling end for telescoping insertion into the female pipe. A clamping collar surrounds the pipes and couples the pipes together. Exhaust couplings of a variety of configurations are well known in the art. An example of such a configuration is shown in U.S. Pat. No. 6,557,908. The exhaust coupling disclosed in this U.S. patent includes a female pipe having a first coupling end and a male pipe having a second coupling end for telescoping insertion into the female pipe. The exhaust coupling includes a band that surrounds one of the pipes. This band is welded at one end to the outer pipe and the opposite end of the band has a flange. The flange is fastened to a block by a fastener to clamp the band about the pipes to retain the pipes coupled together. The block also engages a notch in the outer pipe to prevent rotation.

### SUMMARY OF THE INVENTION AND ADVANTAGES

The present invention provides a coupling for an exhaust system of a vehicle having an internal combustion engine. The coupling includes a female pipe, a male pipe, and a clamping collar to couple the pipes together. The coupling as disclosed includes a pair of posts and a pair of slots between the clamping collar and the pipes for connecting the pipes. The clamping collar surrounds and slides along one of the pipes and includes an annular cam presenting a pair of openings for sliding the clamping collar over the posts. The annular cam presents an axially facing cam surface having a slope increasing circumferentially from each of the openings for sliding frictional engagement with the posts.

The present invention therefore provides for a coupling that has a clamping collar that is releasable, easily accessible, and withstands vibration from a vehicle and prevents fluid from leaking out of the exhaust connection.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top view of a coupling for an exhaust system,

FIG. 2 is an exploded perspective view of the coupling,

FIG. 3 is a perspective view of the coupling,

FIG. 4 is a perspective view of a clamping collar,

FIG. 5 is a front view of the coupling, and

FIG. 6 is a cross-sectional view of the coupling.

### DETAILED DESCRIPTION OF THE INVENTION

Referring to the Figures, wherein like numerals indicate corresponding parts throughout the several views, a coupling 20 for an exhaust system of a vehicle having an internal combustion engine is generally shown.

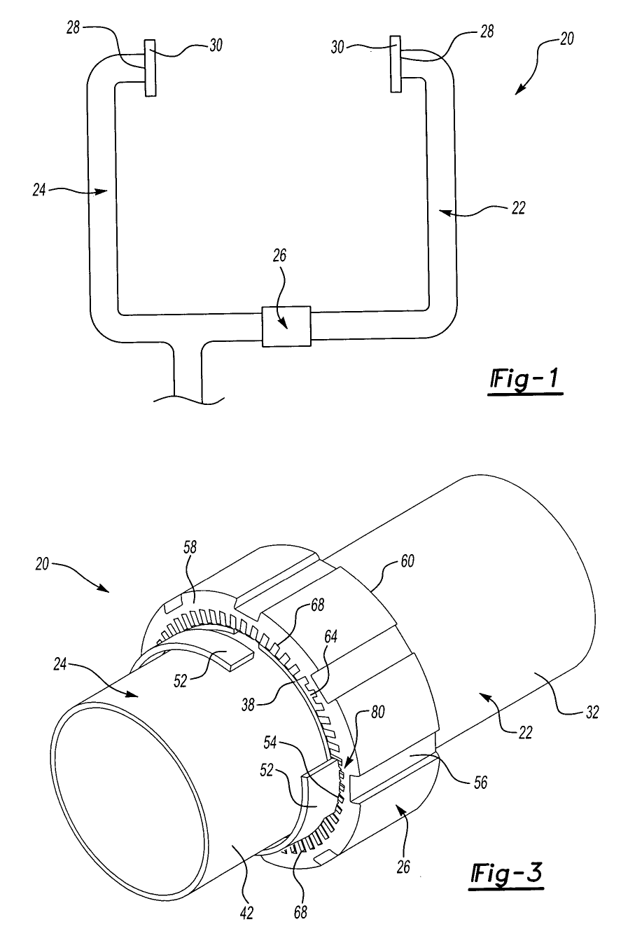

As shown in FIG. 1, the coupling 20 includes a female pipe generally indicated at 22, a male pipe generally indicated at 24, and a clamping collar generally indicated at 26, wherein the clamping collar 26 couples the pipes 22, 24 together. The female and male pipes 22, 24 each have a distal end 28, wherein each distal end 28 includes a manifold connection 30 for connecting the coupling 20 to an exhaust manifold (not shown) of the vehicle. Preferably, the female pipe 22, the male pipe 24 and the clamping collar 26 are formed from a metal, such as steel. Even more preferable, the pipes 22, 24 and clamping collar 26 are formed from a stainless steel. However, it is to be appreciated that the pipes 22, 24 and the clamping collar 26 may be formed from any other acceptable material. In the disclosed embodiment, the clamping collar 26 is made from any known process, but the preferred process is sintering using powdered metals.

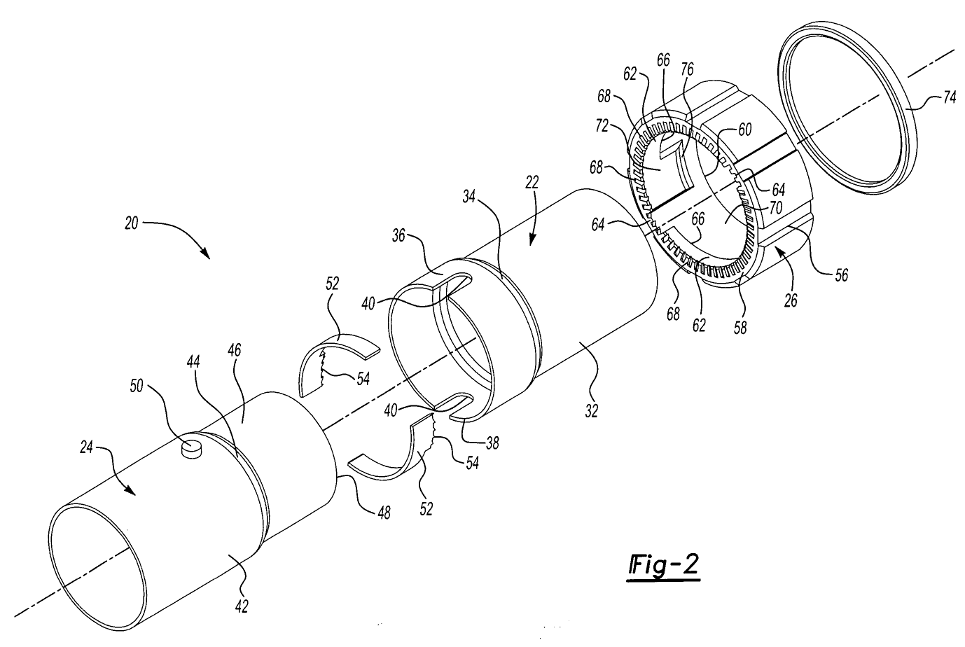

Referring to FIG. 2, the female pipe 22 includes a first coupling end 32 and a female shoulder 34 that extends radially outwardly from the first coupling end 32. The female shoulder 34 of the female pipe 22 includes an enlarge female section 36 that terminates in a receiving edge 38 for mating with the male pipe 24.

The male pipe 24 includes a second coupling end 42 and a male shoulder 44 extending radially inwardly from the second coupling end 42. The male shoulder 44 presents a reduced male section 46 terminating in a leading edge 48 for telescoping insertion into the female pipe 22. If desired, an o-ring (not shown) may be disposed between the female pipe 22 and the male pipe 24.

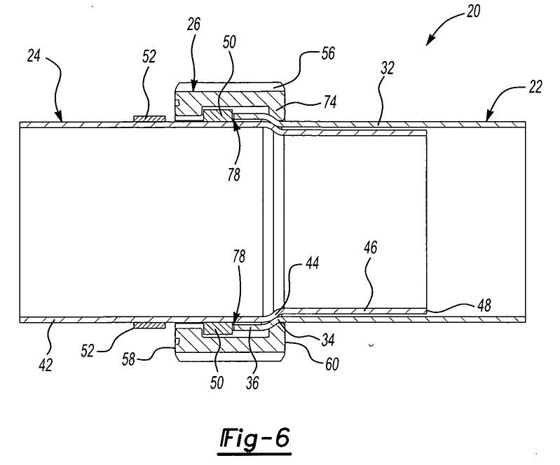

Referring to FIGS. 2 and 6, the coupling 20 further includes a post and slot connection generally indicated at 78. The post and slot connection 78 is disposed between the clamping collar 26 and the pipes 22, 24 for connecting the pipes 22, 24. In the disclosed embodiment, the post and slot connection 78 includes a pair of posts 50 spaced axially from the male shoulder 44 and extending radially outwardly in opposite directions from the male pipe 24. The posts 50 may be attached to the male pipe 24 by welding. However, it is to be appreciated that the posts 50 may be integral with the male pipe 24 or attached to the male pipe 24 in any other acceptable method known in the art. The post and slot connection 78 further includes a pair of slots 40 extending into the receiving edge 38 of the first coupling end 32 of the female pipe 22, wherein the slots 40 receive the posts 50 of the male pipe 24 to prevent rotation of the pipes 22, 24 relative to each other. The posts 50 are formed from a metal, such as steel. Even more preferably, the posts 50 are formed from a stainless steel. However, it is to be appreciated that the posts 50 may be formed from any other acceptable material.

As best shown in FIGS. 2, 3, and 4, the clamping collar 26 may surround and slide along one of the pipes 22, 24. Preferably, the clamping collar 26 surrounds and slides along the female pipe 22. The clamping collar 26 may include a plurality of grips 56 disposed annularly about the clamping collar 26 for manually rotating the clamping collar 26. In another embodiment, the clamping collar 26 may be welded to one of the pipes 22, 24 and the other pipe is rotated to lock the pipes 22, 24 together.

The clamping collar 26 includes a radial receiving face 58 and a radial locking face 60 with the clamping collar 26 extending axially therebetween. Preferably, the post and slot connection 78 is disposed between the locking face 60 of the clamping collar 26 and the male pipe 24. The clamping collar 26 further includes an annular cam 62 extending radially inwardly from the receiving face 58. The annular cam 62 defines a pair of openings 64 for sliding the clamping collar 26 over the posts 50 of the male pipe 24. The annular cam 62 includes an axially facing cam surface 66 having a slope increasing circumferentially from each of the openings 64 for sliding frictional engagement with the posts 50 of the male pipe 24.

The clamping collar 26 includes a sleeve surface 70 facing inwardly and extending axially between the locking face 60 and the annular cam 62. The sleeve surface 70 presents a ridge 72 extending axially from each of the openings 64 on the opposite side thereof from the cam surface 66 to allow movement of the posts 50 only along the cam surface 66 in response to rotation of the clamping collar 26 upon insertion of the posts 50 into the openings 64.

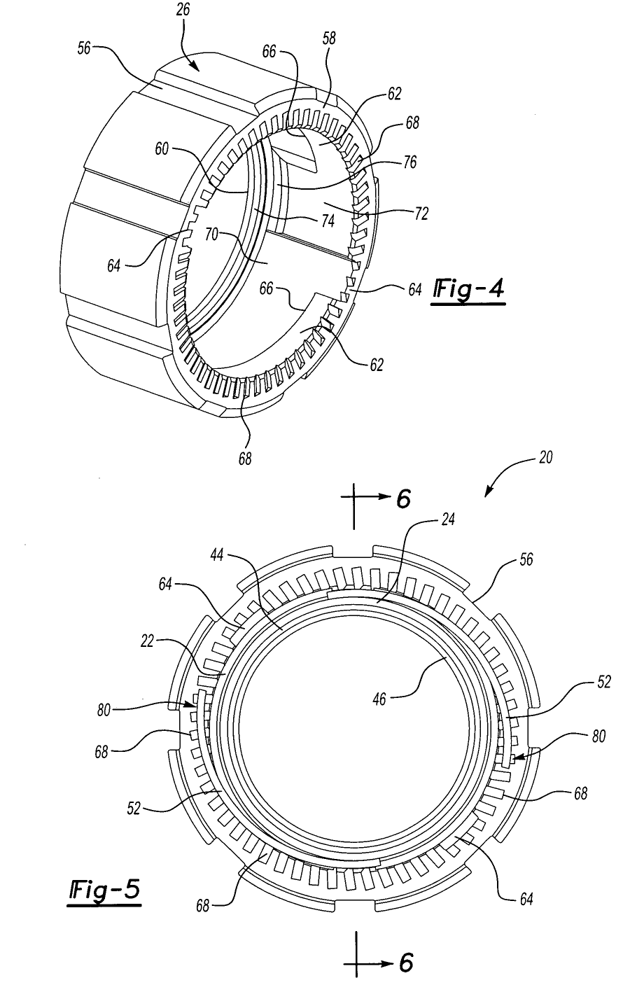

As best shown in FIGS. 2 and 4, the clamping collar 26 further includes an annular ring 74 extending radially inwardly from the locking face 60 for engaging the female shoulder 34 of the female pipe 22 to create a seal between the female shoulder 34 and the male shoulder 44 of the male pipe 24. Preferably, the annular ring 74 is disposed on the sleeve surface 70 within the clamping collar 26. The ridge 72 defines a recess 76 adjacent the annular ring 74 to aid in attaching the annular ring 74 to the clamping collar 26. In the disclosed embodiment, the recess 76 is angled at 240 degrees. However, it is to be appreciated that the recess 76 may be oriented at any angle to aid in attaching the annular ring 74. In the disclosed embodiment, the annular ring 74 is sinter-bonded to the clamping collar 26. It is contemplated that the annular ring 74 may be integral with the clamping collar 26 or attached to the clamping collar 26 by any other process known in the art.

As best shown in FIGS. 3 and 5, the coupling may include a ratchet mechanism which is generally indicated at 80. The ratchet mechanism 80 interconnects the clamping collar 26 and one of the pipes 22, 24 for preventing rotation of the clamping collar 26 relative to the pipes 22, 24 to retain the pipes 22, 24 coupled together. The ratchet mechanism 80 includes a plurality of inclined serrations 68 on the clamping collar 26 and a plurality of inclined teeth 54 on a finger 52 attached to one of the pipes 22, 24 respectively. The inclined serrations 68 and the inclined teeth 54 bias into ratcheting engagement with one another. Preferably, the inclined serrations 68 are disposed in the receiving face 58 of the clamping collar 26 and the inclined teeth 54 are disposed on the male pipe 24. However, it is to be appreciated that the inclined serrations 68 may be disposed anywhere on the clamping collar 26 as long as the inclined serrations 68 engage the inclined teeth 54. The inclined serrations 68 are disposed next to one another circumferentially between the openings 64 of the annular cam 62. It is contemplated that the inclined serrations 68 may be eliminated from the openings 64. In the disclosed embodiment, the inclined serrations 68 are angled at 300 degrees. The angle of the incline serrations 68 aid in moving the finger 52 out of the way while the clamping collar 26 is rotated. The finger 52 moves back into locking position with the inclined serration 68 when the pipes 22, 24 are clamped together and the rotation of the clamping collar 26 stops. However, it is to be appreciated that the angle of the inclined serrations 68 and inclined teeth 54 may be oriented at any angle as long as the inclined serrations 68 and the inclined teeth 54 engage one another.

Referring to FIGS. 2, 3, and 5, at least one finger 52 is disposed on an exterior of one of the pipes 22, 24. Preferably, the finger 52 is attached to the male pipe 24 in an axially spaced relationship to the clamping collar 26. The finger 52 extends circumferentially in a leaf-spring fashion to a cantilevered extremity presenting the inclined teeth 54 and biases into ratcheting engagement with the inclined serrations 68. To release the clamping collar 26, the finger 52 is movable radially relative to one another to release the inclined teeth 54 from the inclined serrations 68 to rotate the clamping collar 26 and release the pipes 22, 24. In the disclosed embodiment, there is a clearance of 1 millimeter plus the thickness of the female pipe 22 between the male pipe 24 and the inclined serrations 68 of the clamping collar 26 to aid in releasing the clamping collar 26 from the finger 52. However, one skilled in the art would appreciate that the clearance and the thickness of the female pipe 22 may vary in order to aid in releasing the clamping collar 26 from the finger 52. The finger 52 may be attached to the male pipe 24 by welding. However, it is to be appreciated that the finger 52 may be integral with the male pipe 24 or attached to the male pipe 24 in any other acceptable method known in the art. The finger 52 is formed from a metal, such as steel. Even more preferably, the finger 52 is formed from a stainless steel. However, it is to be appreciated that the finger 52 may be formed from any other acceptable material.

The foregoing invention has been described in accordance with the relevant legal standards; thus, the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A coupling for an exhaust system of a vehicle having an internal combustion engine, said coupling comprising:
a female pipe having a first coupling end,
a male pipe having a second coupling end for telescoping insertion into said female pipe,
a clamping collar surrounding and slidable along one of said pipes,
a post and slot connection having a pair of posts and a pair of slots between said clamping collar and said pipes for connecting said pipes,
said clamping collar including an annular cam presenting a pair of openings for sliding said clamping collar over said posts, and
said annular cam presenting an axially facing cam surface having a slope increasing circumferentially from each of said openings for sliding frictional engagement with said posts.

2. A coupling as set forth in claim 1 wherein said clamping collar includes a radial receiving face and a radial locking face with said clamping collar extending axially therebetween and a sleeve surface facing inwardly and extending axially between said locking face and said annular cam and presenting a ridge extending axially from each of said openings on the opposite side thereof from said cam surface to allow movement of said posts only along said cam surface in response to rotation of said clamping collar upon insertion of said posts into said openings.

3. A coupling as set forth in claim 2 including a ratchet mechanism interconnecting said clamping collar and one of said pipes for preventing rotation of said clamping collar relative to said pipes to retain said pipes coupled together.

4. A coupling as set forth in claim 3 wherein said ratchet mechanism includes a plurality of inclined serrations in said receiving face of said clamping collar and disposed next to one another circumferentially between said openings.

5. A coupling as set forth in claim 4 wherein said female pipe includes a female shoulder extending radially outwardly from said first coupling end and presents an enlarged female section terminating in a receiving edge and said male pipe includes a male shoulder extending radially inwardly from said second coupling end and presents a reduced male section terminating in a leading edge and said post and slot connection is disposed between said locking face of said clamping collar and said male pipe and said posts are spaced axially from said male shoulder and extend radially outwardly in opposite directions from said male pipe and said slots extend into said receiving edge of said first coupling end of said female pipe for receiving said posts of said male pipe.

6. A coupling as set forth in claim 5 wherein said clamping collar includes an annular ring extending radially inwardly from said locking face for engaging said female shoulder.

7. A coupling as set forth in claim 1 including grips disposed annularly about said clamping collar for manually rotating said clamping collar.

8. A coupling for an exhaust system of a vehicle having an internal combustion engine, said coupling comprising:
a female pipe having a first coupling end,
a male pipe having a second coupling end for telescoping insertion into said female pipe,
a clamping collar surrounding and slidable along one of said pipes,
a post and slot connection between said clamping collar and said pipes for connecting said pipes,
a ratchet mechanism interconnecting said clamping collar and one of said pipes for preventing rotation of said clamping collar relative to said pipes to retain said pipes coupled together,
said ratchet mechanism including a plurality of inclined serrations and inclined teeth on said clamping collar and one of said pipes respectively and biased into ratcheting engagement with one another for preventing rotation of said clamping collar relative to said pipes, and
at least one finger attached to the exterior of one of said pipes in an axially spaced relationship to said clamping collar and extending circumferentially in leaf-spring fashion to a cantilevered extremity presenting one of said inclined serrations and inclined teeth and for biasing said inclined serrations and inclined teeth into ratcheting engagement and movable radially relative to one another to release said inclined teeth from said inclined serrations to rotate said clamping collar.

9. A coupling as set forth in claim 8 wherein said finger is disposed on said male pipe.

10. A coupling as set forth in claim 9 wherein said female pipe includes a female shoulder extending radially outwardly from said first coupling end.

11. A coupling as set forth in claim 10 wherein said female shoulder of said female pipe includes an enlarged female section terminating in a receiving edge.

12. A coupling as set forth in claim 11 wherein said male pipe includes a male shoulder extending radially inwardly from said second coupling end.

13. A coupling as set forth in claim 12 wherein said male shoulder of said male pipe includes a reduced male section terminating in a leading edge.

14. A coupling as set forth in claim 13 wherein said clamping collar includes a radial receiving face and a radial locking face with said clamping collar extending axially therebetween and said inclined serrations of said ratchet mechanism disposed on said receiving face of said clamping collar.

15. A coupling as set forth in claim 14 wherein said post and slot connection is disposed between said locking face of said clamping collar and said male pipe and includes a pair of posts spaced axially from said male shoulder and extending radially outwardly in opposite directions from said male pipe.

16. A coupling as set forth in claim 15 wherein said post and slot connection includes a pair of slots extending into said receiving edge of said first coupling end of said female pipe for receiving said posts of said male pipe.

17. A coupling as set forth in claim 16 wherein said clamping collar includes an annular cam extending radially inwardly from said receiving face and presenting a pair of openings for sliding said clamping collar over said posts with said inclined serrations disposed next to one another circumferentially between said openings.

18. A coupling as set forth in claim 17 wherein said annular cam presents an axially facing cam surface having a slope increasing circumferentially from each of said openings for sliding frictional engagement with said posts.

19. A coupling as set forth in claim 18 wherein said clamping collar includes an annular ring extending radially inwardly from said locking face for engaging said female shoulder.

20. A coupling as set forth in claim 19 wherein said clamping collar includes a sleeve surface facing inwardly and extending axially between said locking face and said annular cam and presenting a ridge extending axially from each of said openings on the opposite side thereof from said cam surface to allow movement of said posts only along said cam surface in response to rotation of said clamping collar upon insertion of said posts into said openings.

21. A coupling as set forth in claim 1 including grips disposed annularly about said clamping collar for manually rotating said clamping collar.

22. A coupling for an exhaust system of a vehicle having an internal combustion engine, said coupling comprising:
a female pipe having a first coupling end defined by a female shoulder extending radially outwardly from said first coupling end and presenting an enlarged female section terminating in a receiving edge,
a male pipe having a second coupling end defined by a male shoulder extending radially inwardly from said second coupling end and presenting an reduced male section terminating in a leading edge for telescoping insertion into said female section,
a clamping collar extending axially between a radial receiving face and a radial locking face surrounding and slidable along said female pipe,
said clamping collar presenting an annular ring extending radially inwardly from said locking face for engaging said female shoulder,
a post and slot connection between said locking face of said clamping collar and said male pipe for connecting said pipes defined by a pair of posts spaced axially from said male shoulder of said male pipe and extending radially outwardly in opposite directions from said male pipe and a pair of slots extending into said receiving edge of said first coupling end of said female pipe for receiving said posts,
said clamping collar including an annular cam extending radially inwardly from said receiving face,
said annular cam of said clamping collar presenting a pair of openings for sliding said clamping collar over said posts to engage said annular ring with said female shoulder,
said annular cam presenting an axially facing cam surface having a slope increasing circumferentially from each of said openings for sliding frictional engagement with said posts,
said clamping collar having a sleeve surface facing inwardly and extending axially between said locking face and said annular cam and presenting a ridge extending axially from each of said openings on the opposite side thereof from said cam surface to allow movement of said posts only along said cam surface in response to rotation of said clamping collar upon insertion of said posts into said openings,
a ratchet mechanism interconnecting said clamping collar and said male pipe for preventing rotation of said clamping collar relative to said male pipe to retain said pipes coupled together,
said ratchet mechanism including a plurality of inclined serrations in said receiving face of said clamping collar and disposed next to one another circumferentially between said openings and a pair of fingers attached diametrically opposite to one another on said male pipe and each extending circumferentially in leaf-spring fashion to a cantilevered extremity presenting inclined teeth biased into ratcheting engagement with said inclined serrations and movable radially to release said inclined teeth from said inclined serrations to rotate said clamping collar, and
grips disposed annularly about said clamping collar for manually rotating said clamping collar.
